(19) United States
(12) Patent Application Publication
(10) Pub. No.: US 2006/0265815 A1
(43) Pub. Date: Nov. 30, 2006

(54) Antimicrobial matrix

(75) Inventors: Maurice Clarence Kemp, Gold River, CA (US); David E. Lewis, Eau Claire, WI (US)

Correspondence Address: T. Ling Chwang, Suite 6000, 901 Main Street, Dallas, TX, 75202, US

(73) Assignee: Mionix Corporation, Rocklin, CA (US)

(21) Appl. No.: 11/432,911

(22) Filed: May 12, 2006

Related U.S. Application Data
(60) Provisional application No. 60/680,222, filed on May 12, 2005.

(51) Int. Cl. C11D 3/00

(52) U.S. Cl. 8/115.51

(57) ABSTRACT

An antimicrobial matrix and its preparation. A matrix having its surface coupled to a quaternary ammonium cation. The matrix has functional groups on its surface capable of coupling to an organic moiety containing the quaternary ammonium cation. The functional groups include the hydroxyl groups of cellulose. The antimicrobial matrix prevents the growth of microbes, such as molds, on the matrix. Examples of the matrix include a paper product, a wallboard paper, cotton, linen, wool, and silk.

This application claims priority to U.S. Provisional Patent Application, Ser. No. 60/680,222, entitled “Antimicrobial Matrix” filed on May 12, 2005, having Kemp et al., listed as the inventor(s), the entire content of which is hereby incorporated by reference.

### BACKGROUND

This invention relates to an antimicrobial matrix and its preparation. More specifically, this invention relates to a matrix having its surface coupled to a quaternary ammonium cation. The matrix has functional groups on its surface capable of coupling to an organic moiety containing the quaternary ammonium cation. The functional groups include the hydroxyl groups of cellulose. The antimicrobial matrix prevents the growth of microbes, such as molds, on the matrix. Examples of the matrix include a paper product, a wallboard paper, cotton, linen, wool, and silk.

Drywall. Drywall is the principal wall material used in the United States for interior purposes. Approximately 15 million tons of new drywall is produced each year in the U.S., and an estimated 1.8 million tons of new drywall is produced in California. The building industry manufactures and installs over 1,000,000,000 gypsum wall boards annually in this country.

Drywall is made of a sheet of gypsum covered on both sides with a paper facing and a paperboard backing. Drywall comes in many different types and sizes to meet specific construction needs. Several specialty products are manufactured including moisture resistant drywall (greenboard) and Type X drywall. Type X drywall contains small glass fibers designed to increase the board's ability to withstand high temperatures from fires for a longer period of time.

Gypsum, a naturally occurring mineral, is composed of calcium sulfate (CaSO₄) and water (H₂O). Also referred to as hydrous calcium sulfate (CaSO₄∘2H₂O), gypsum is mined from deposits formed by ancient sea beds, as a raw material for many different manufacturing, industrial, and agricultural uses. Over 80% of the gypsum mined is used in manufactured products such as drywall. Gypsum possesses many attributes that make it an attractive construction material. Calcined gypsum can be wetted to form a paste that can be directly applied to a structure's surface or that can be molded into a desired shape; the gypsum hardens upon drying. Gypsum is naturally fire resistant.

Gypsum drywall, often referred to as gypsum wallboard or sheet rock, replaced gypsum plaster as the major material used for interior wall surfaces because of its ease of installation. Wallboard gypsum can act as a water conduit, thereby facilitating water transport such that it comes in contact with wall board paper. Gypsum drywall consists of approximately 90% gypsum and 10% paper facing and backing. Drywall is manufactured by first calcining the gypsum, a process that heats the mineral to remove part of the water (resulting in CaSO₄.½H₂O). The stucco that is formed is then re-hydrated by mixing with water, and the slurry created is spread onto a moving continuous sheet of paper and sandwiched between another layer of paper. This continuous sheet of wallboard is allowed to harden for several minutes, cut into panels and sent to a kiln for final drying. It is trimmed to the dimensions required, bundled, and is then ready for shipment. Drywall comes in many different types and sizes to meet specific construction needs

Fungi and Health: Fungi are common in nature and serve a central role as breakdown agents for organic matter. They contain fragments, or spores, which are found in virtually every home and building.

Stachybotrys chartarum (“SC”), or “black mold,” is a greenish black fungus that grows on material with a high cellulose and low nitrogen content, such as fiberboard, gypsum board, paper, dust, and lint, that become chronically moist or water damaged due to excessive humidity, water leaks, condensation, water infiltration, or flooding. Wet paper can be an ideal food source and support the growth of “black mold.” No one knows how often this fungus is found since buildings are not routinely tested for its presence. However, one study in Southern California found it in 2.9% of 68 homes SC may (under specific environmental conditions) produce several toxic chemicals called mycotoxins. These chemicals are present on the spores and the small fungus fragments that are released into the air. Although spores and other parts of this fungus are usually trapped in a wet, slimy mass of fungal growth, many health officials are concerned that spores may become airborne when the fungus dies and dries up. Because SC spores are very small, some may be drawn into the lungs when airborne spores are inhaled.

The health effects of SC were first noted as diseases in Russian and Eastern European farm animals that ate moldy hay. The first reported human effects were seen in agricultural workers who handled the moldy straw or hay that was affecting the farm animals. After consuming contaminated cereal grains, people experienced symptoms included burning sensations in the mouth, nausea, vomiting, diarrhea and abdominal pain. SC in humans is much less common than in animals, and no lethal cases have been reported. Nevertheless, the mycotoxin of the “black mold” causes pulmonary hemosiderosis in human, that is, bleeding in the lungs. Further, SC also produces cyclosporine, and immuno-suppressant often used for organ transplants. It has also been suggested that SC is responsible for “sick building syndrome.”

If SC spores are released into the air, there is a potential for humans to develop symptoms such as coughing, wheezing, runny nose, irritated eyes or throat, skin rash, or diarrhea. There are a few reports in the scientific literature of improvement of symptoms when people left an area where SC or other molds were found, or after moldy materials were removed from a dwelling or workplace.

Prevention of Mold in Dwellings:

One method of preventing mold is to use moisture-resistant wallboard paper. Better yet, it is desirable to have a product that can be applied to wallboard paper which product prevents the growth of mold when the wallboard paper becomes wet. The prospective treatment must be fixed in place, relatively non-toxic, and remain active for the life of the installed wallboard. Further, the treatment must be economical and the method of application should not radically alter manufacturing processes.

The composition of the present invention is designed to be applied to wallboard paper or drywall that will prevent the growth of microbes, in particular, mold, such as “black mold.”

### SUMMARY

This invention relates to an antimicrobial matrix and its preparation. More specifically, this invention relates to a matrix having its surface coupled to a quaternary ammonium cation. The matrix has functional groups on its surface capable of coupling to an organic moiety containing the quaternary ammonium cation. The functional groups include the hydroxyl groups of cellulose. The antimicrobial matrix prevents the growth of microbes, such as molds, on the matrix. Examples of the matrix include a paper product, a wallboard paper, cotton, linen, wool, and silk.

One aspect of the present invention is a cellulose-containing matrix conjugated with a quaternary ammonium cation. The quaternary ammonium ion is coupled to the cellulose matrix by by silane-, urethane- or ether-linkages. The bridge or linkage between the cellulose matrix and the quaternary ammonium ion is an α,ω-disubstituted alkylene chain carrying the quaternary nitrogen at one end and the silane, urethane, or ether group at the other.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows silane coupling technology.

FIG. 2 shows a twin-application urethane coupling technology.

FIG. 3 shows a single-application urethane coupling technology.

FIG. 4 shows a twin-application ether coupling technology.

### DETAILED DESCRIPTION OF PREFERRED EMBODIMENTS

The present invention pertains to a matrix containing cellulose wherein the cellulose is conjugated with a quaternary ammonium cation. The quaternary ammonium cation is conjugated to the cellulose in the matrix by silane-, urethane-, or ether-coupling. The bridge between the cellulose and the quaternary ammonium cation is an α,ω-disubstituted alkylene chain carrying the quaternary nitrogen at one end and the saline, urethane, or ether group at the other. The matrix can be a paper product, such as a construction paper or a drywall paper. The matrix can also be cotton-, linen-, wool-, or silk-product. Preferably, the matrix contains cellulose strands.

The following examples are provided to further illustrate this invention and the manner in which it may be carried out. It will be understood, however, that the specific details given in the examples have been chosen for purposes of illustration only and should not be construed as limiting the invention.

### EXAMPLE 1

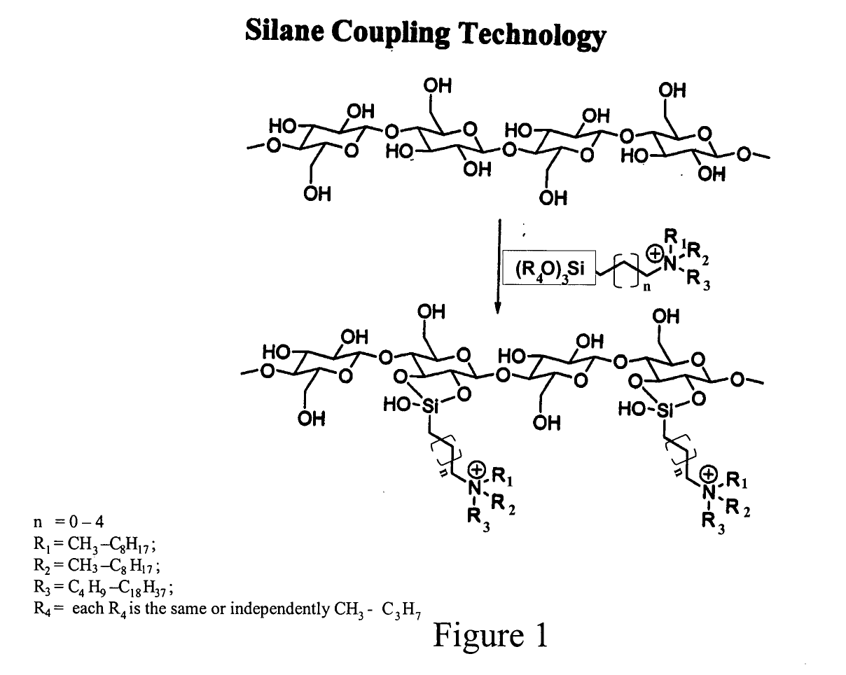

FIG. 1 shows what happens chemically in one of the possibilities for a specific silane coupling technology. Broadly, the cellulose fibers, with a large number of hydroxyl groups, are converted to silyl ether linkages by the reaction with trialkoxysilane reagent carrying a quaternary ammonium cation side chain. The initial ether formation is fairly rapid in an aqueous-alcoholic solvent, or water, at room temperature but it requires heat curing to maximize the number of silyl ether bonds or to eliminate silanol groups and form cross-linking siloxane groups. At least two such silyl ether bonds are required to hold the silane strongly to the surface of the paper, but his may also involve ether linkages between silane groups (siloxane groups). The silyl group could cross two strands of cellulose fibers, could cross three strands of cellulose, could form ring within a strand, or could form a Si—O—Si siloxane bridge. Each of the alkoxy group (OR₄) in the trialkoxysilane can be the same or different and independently be alkoxy of 1 to 3 carbons, preferably 2 carbons, such as ethoxy group. There could be from 2 to 6 of methylene groups joining the Si and N in the trialkoxysilane, preferably 3 methylene groups. R₁ and R₂ of the quaternary ammonium cation side chain can independently be an alkyl group having from 1 to 8 carbons, preferably a methyl group. R₃ of the quaternary ammonium cation side chain can be an alkyl group having from 4 to 20 carbons, preferably from 14 to 18 carbons.

The trialkoxysilane reagent carrying a quaternary ammonium cation side chain is dissolved in water or an aqueous-alcoholic solvent to form a treatment solution or suspension, which can be diluted in an appropriate solvent before use, and is allowed to make contact with the matrix, such as a wallboard paper, at room temperature. The “contacting” can be accomplished by spraying or pouring the treatment solution or suspension onto the matrix. Alternatively, the matrix can be dipped into the treatment solution or suspension. After the treatment, the matrix is allowed to dry at ambient temperature and could also be later cured at high temperature, such as between 100 to 150 degrees C.

### EXAMPLE 2

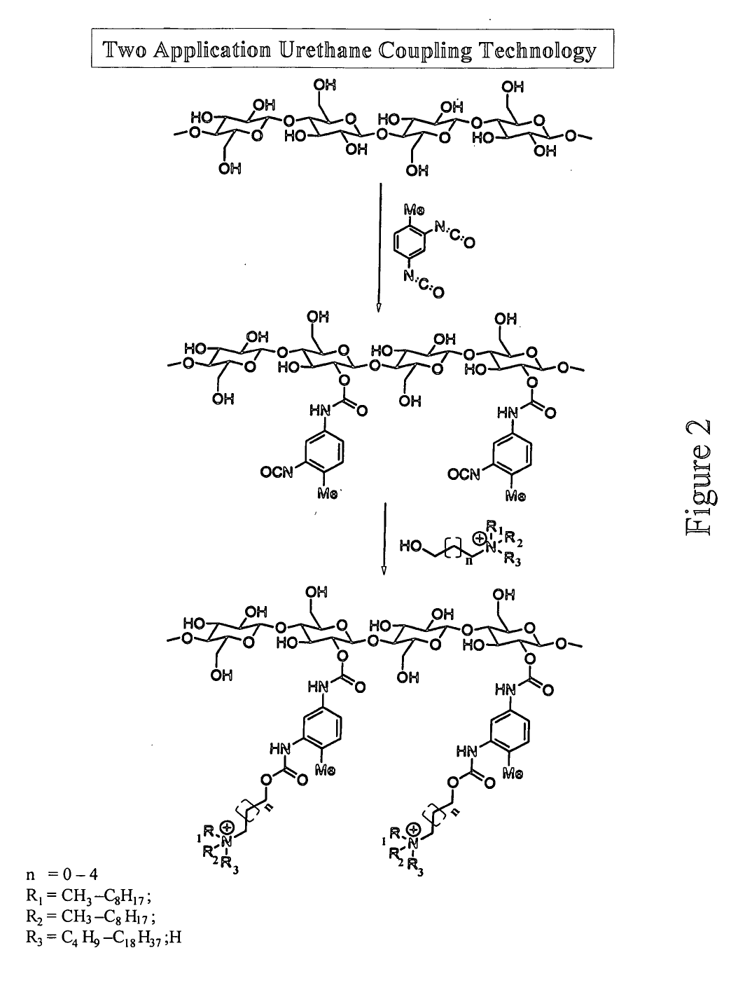

FIG. 2 shows a twin-application, or two-step, urethane coupling technology. Here the coupling of the cellulose in the matrix and the quaternary ammonium salt is accomplished by the formation of urethanes to toluenediisocyanate (“TDI”), a common component of polyurethane foams. The cellulose is treated with TDI in a non-hydroxylic solvent such as ethyl acetate (or the liquid may be atomized directly onto the surface), and the paper is allowed to stand for a short while at room temperature to allow complete formation of the urethane groups on the surface. A second solution containing the quaternary ammonium ion is then sprayed onto the surface (again, ethyl acetate is a preferred solvent), and the matrix is now heated to complete the surface derivatization. The net result is a bis-urethane which couples the surface and the quaternary salt. If necessary, both derivatization steps in this approach may be carried out at or near room temperature; the urethane formed is quite heat stable.

Although TDI is shown in the scheme, any m- or p-phenylene diisocyanate and its substituted analog can be used. Alternatively any aliphatic diisocyanate not capable of forming a cyclic urea on reaction with an alcohol can also be used. Thus, phenylenediisocyanate or xylylenediisocyanate can also be used.

The trialkoxysilane reagent carrying a quaternary ammonium cation side chain used in this coupling technology is the same as the one described above.

### EXAMPLE 3

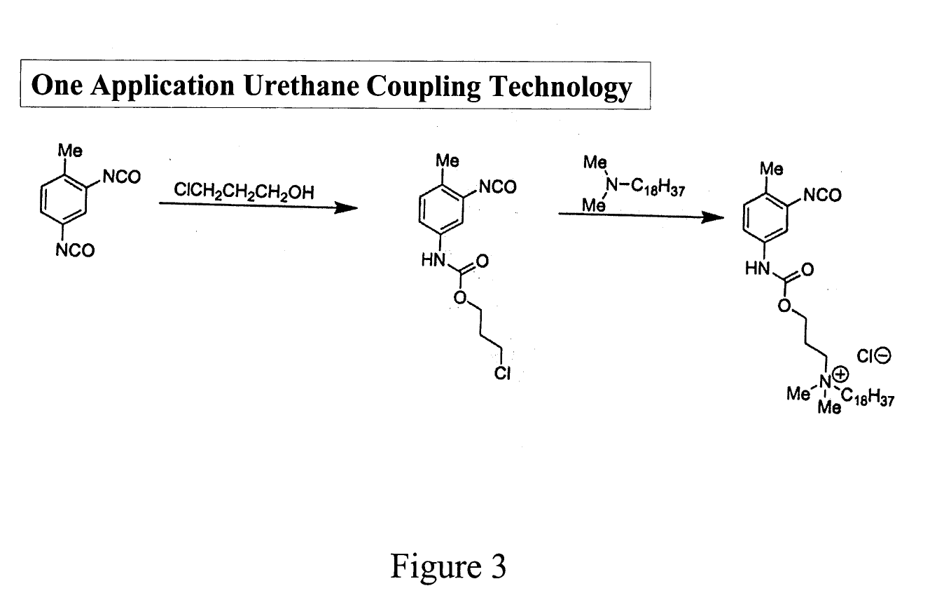

FIG. 3 shows a preferred single-application, or one-step, urethane coupling technology. First an aryl, or substituted aryl, diisocyanate, such as toluenediisocyanate is dissolved in anhydrous ethyl acetate to make a solution that is about 10% w/v isocyanate. Next, to this stirred solution is added slowly about 1 mole equivalent of an ω-halo-1-alkanol (preferably Br or Cl) having from 2 to 8 carbons, such as 3-chloro-1-propanol, at room temperature. If the temperature in the reaction mixture rises too much, then, the rate of addition of the alcohol is decreased. After all the alcohol has been added, the mixture is stirred for about an hour to ensure that the formation of the mono-urethane is complete. Then about one full mole equivalent of a tertiary amine, preferably a tertiary amine such as N,N-dimethyloctadecylamine, is added to the solution, and the solution is heated for about 1 hour (or a little more if needed) to complete the displacement reaction forming a quaternary salt containing both urethane and isocyanate groups. This solution is then sprayed onto a matrix, such as a wallboard paper, and the solvent is allowed to evaporate. The surface may be heated to complete the reaction and to cure the surface bound material. Unbound material may be removed by washing with ethyl acetate.

In one example, to 9.45 g of 3-chloro-1-propanol in sufficient of anhydrous ethyl acetate was added 17.45 g of toluene-2,4-diisocyanate. The reaction was allowed to proceed at room temperature overnight. Then 20 g of N,N-dimethylhexadecylamine was added to the reaction mixture. After the completion of reaction, the resultant reaction mixture was sprayed, either neat or diluted, onto a matrix, allowed to dry briefly at room temperature and then heated to about 62° C. until substantially dry.

### EXAMPLE 4

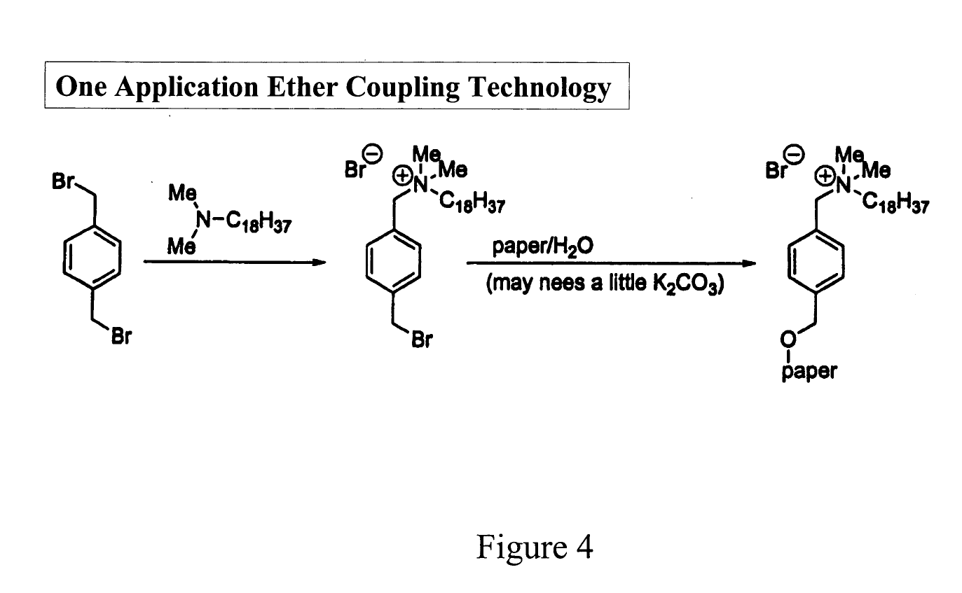

FIG. 4 shows a twin-application, or two-step, ether coupling technology. This process starts with a dihalide of m- or p-xylene or its substituted derivative, but should not be capable of forming a cyclic ether. The α,α′-dibromo-p-xylene is a preferred starting material. Displacement of one of the halogens with an amine, preferably a tertiary amine, such as N,N-dimethyloctadecylamine, gives the corresponding mono-quaternary salt still carrying a reactive benzyl bromide group. The solvent used can be a suitable organic solvent, such as acetone, ethyl acetate, or a short chain alcohol. The reaction product then is allowed to react with the surface of a matrix, such as a paper (especially the “mercerized” paper which is first treated with an alkali, such as KOH, to give the ether linkage). The treated paper is very heat-stable.

Aspergillus is a filamentous, cosmopolitan and ubiquitous fungus found in nature. It is commonly isolated from soil, plant debris, and indoor air environment. The genus Aspergillus includes over 185 species. Around 20 species have so far been reported as causative agents of opportunistic infections in man. Among these, Aspergillus fumigatus is the most commonly isolated species, followed by Aspergillus flavus and Aspergillus niger. Aspergillus clavatus, Aspergillus glaucus group, Aspergillus nidulans, Aspergillus oryzae, Aspergillus terreus, Aspergillus ustus, and Aspergillus versicolor are among the other species less commonly isolated as opportunistic pathogens.

Aspergillus spp. are well-known to play a role in three different clinical settings in man: (i) opportunistic infections; (ii) allergic states; and (iii) toxicoses. Immunosuppression is the major factor predisposing to development of opportunistic infections. These infections may present in a wide spectrum, varying from local involvement to dissemination and as a whole called aspergillosis.

From an environmental perspective for mold growth to occur, three conditions are required: (1) Temperatures between 5° C. and 38° C.; (2) Nutrients, i.e. dirt, soil, cellulose, paper, insulation, etc.; and (3) Water (water can occur as a result of floods, roof leaks, condensation, humid rooms, damp basements etc.)

Given these conditions Aspergillus fumigatus will grow rapidly. For the present studies, cetyl dimetylamine was conjugated as described through a urethane linkage to paper.

One cm×1 cm squares were cut from untreated and treated paper. The control and treated papers were dipped in a suspension of Aspergillus fumigatus. The squares were then placed on the surface of an agar plate. The agar was formulated with mould culture media. Plates were cultured anywhere form five to 30 days at 20° or 35° C. Grey green spore development took anywhere from 5 to 10 days depending on culture conditions.

Aspergillus fumigatus growth occurred only on the control paper and not the treated paper in all circumstances.

One skilled in the art readily appreciates that this invention is well adapted to carry out the objectives and obtain the ends and advantages mentioned as well as those inherent therein. The compositions, methods, procedures and techniques described herein are presently representative of the preferred embodiments and are intended to be exemplary and are not intended as limitations of the scope. Changes therein and other uses will occur to those skilled in the art which are encompassed within the spirit of the invention or defined by the scope of the pending claims.

### REFERENCES CITED

The following references, to the extent that they provide exemplary procedural or other details supplementary to those set forth herein, are specifically incorporated herein by reference.

U.S. Patent Documents

U.S. Pat. No. 6,159,410 issued to Haga on Dec. 12, 2000, titled “Gypsum-based Composite Article and Method for Producing Same.”

What is claimed is:

1) An antimicrobial matrix comprising a matrix having its surface coupled to a quaternary ammonium cation.

2) An antimicrobial matrix comprising a matrix having functional groups on its surface capable of coupling to an organic moiety containing a quaternary ammonium cation.

3) An antimicrobial matrix comprising a cellulose-containing matrix wherein the cellulose is conjugated with a quaternary ammonium cation.

4) The matrix of claim 3, wherein the quaternary ammonium cation is conjugated to the cellulose by silane-, urethane-, or ether-coupling.

5) The matrix of claim 3, wherein a bridge is formed between the cellulose and the quaternary ammonium cation, and the bridge is an α,ω-disubstituted alkylene chain carrying the quaternary nitrogen at one end and the silane, urethane, or ether group at the other.
